(19) United States
(12) Patent Application Publication
(10) Pub. No.: US 2014/0191561 A1
(43) Pub. Date: Jul. 10, 2014

(54) SOLUTION MINING AND A CRYSTALLIZER FOR USE THEREIN

(71) Applicant: 101061615 Saskatchewan Ltd., Beechy (CA)

(72) Inventor: Harvey Haugen, Beechy (CA)

(73) Assignee: 101061615 Saskatchewan Ltd., Beechy (CA)

(21) Appl. No.: 14/158,559

(22) Filed: Jan. 17, 2014

Related U.S. Application Data
(63) Continuation of application No. 13/895,306, filed on May 15, 2013, now abandoned.
Application No. 13/895,306 is a continuation of application No. 12/966,642, filed on Dec. 13, 2010, now abandoned.
(60) Provisional application No. 61/296,731, filed on Jan. 20, 2010.

(51) Int. Cl. E21B 43/28; B01D 9/00; E21B 43/40

(52) U.S. Cl. CPC E21B 43/28; E21B 43/40; B01D 9/0013
USPC 299/4

(57) ABSTRACT

In solution mining, holes are drilled parallel to the ground in the ore body to form a series of zigzag channels. These holes are connected to respective holes from the surface to provide a feed and delivery path and a solvent is circulated through the system so as to dissolve the ore and carry the ore to the surface. The flow of the solvent through the holes forms circular caverns at the intersection of the horizontal hole as well as meanders by eroding the holes so as to gradually extract the ore on each side of the hole. At the surface the ore is extracted in a series of crystallizers each formed by a vessel with an exterior cooling system and an internal wiping system providing shear inside the vessel. The solvent is topped up, reheated and returned to the paths to continue the process.

### CROSS-REFERENCE TO RELATED APPLICATION

This application is a continuation of U.S. patent application Ser. No. 13/895,306, filed on May 15, 2013, which is a continuation of U.S. patent application Ser. No. 12/966,642, filed on Dec. 13, 2010, which claims priority to and the benefit of U.S. Provisional Patent Application No. 61/296,731, filed on Jan. 20, 2010, all of which are incorporated herein by reference in their respective entireties.

### FIELD

This invention relates to methods for solution mining and to crystallizers for use in solution mining.

### BACKGROUND OF THE INVENTION

In-situ leaching (ISL), also called in-situ recovery (ISR) or solution mining, is a process of recovering minerals such as copper and uranium through boreholes drilled into the ore deposit in the earth. The process initially involves drilling holes into the ore deposit. Explosive or hydraulic fracturing may be used to create open pathways in the deposit for solution to penetrate. Leaching solution is pumped into the deposit, where the solution contacts the ore. The leaching solution dissolves the ore and is then pumped to the surface and processed. This process allows the extraction of metals and salts from an ore body without the need for conventional mining involving drill-and-blast, open-cut, or underground mining.

Conventional solution mines create individual caverns, usually by dissolving salt from beneath the ore body. The ore then rubblizes in the cavern and is dissolved in introduced fresh water or dilute brines to form near-saturated solutions at temperatures equal to ore temperature (or slightly higher). The caverns tend to develop vertically and, in some cases, consideration has been given to connecting them.

To recover the ore from the solution in which the ore is dissolved, nearby crystallization systems are necessary on the surface above the mine.

Conventional solution-mining systems present difficulties in raising the mine temperature above the temperature of the ore deposit, as well as obtaining fully saturated brines from the mine. In some conventional systems directed to potash solution mining, potash concentration and temperature are increased using evaporators located on the surface. This tends to be the most expensive part of the mine, and uses large amounts of expensive and exotic metals. Large amounts of steam are also required.

Hot, concentrated brines from the mine are cooled and crystallized in evaporative crystallizers. These crystallizers are limited to cooling the brine to about 25 degrees C. One example of such a mine delivers the cooled brine to ponds, and exploits natural, cold crystallization in open ponds to recover dissolved ore. Use of such ponds rather than crystallization machinery is still an expensive process that requires careful management and expensive dredging equipment. This method is also seasonal with no potential to recover any heat.

### SUMMARY OF THE INVENTION

An object of the invention is to provide improved solution-mining systems and methods. One aspect of the invention is directed to methods. According to an embodiment, an ore body is identified at a position below ground. At least one feed hole is drilled from the surface downwardly to the ore body. Other holes are drilled in directions generally parallel to the ground (i.e., generally horizontal) to connect to the feed hole(s) and extend into the ore body. Thus, selected regions of the ore body are interconnected by these holes, wherein the horizontal holes form respective hydraulic channels extending through the ore body. At least one delivery hole extends from the surface and interconnects to respective hydraulic channels to provide a route for liquid flow from the channels out of the mine. An ore-dissolving solvent is circulated through the feed hole, the channels, and the delivery hole to dissolve the ore and carry the ore as a liquid solution to the surface via the delivery hole.

Thus, the mining system uses at least one hole from the surface to the horizontally drilled holes as a feed path for injecting the solvent. More than one vertical hole can be used if needed for higher flow. Each vertical hole is connected to at least one

The methods described herein are primarily developed for mining of potash; but, the methods can be applied to any other ore material for which solution mining is a practical technique, including uranium, soda ash, and bitumen extraction from tar sands.

Provided herein are simplified methods of solution mining that can be used to extract potash, for example, by solution mining. The potash mine may include a crystallization system, such as an externally circulated wiped surface crystallizer (ECWSC).

Methods described herein produce saturated or nearly saturated brines from a mine. The brines are at high temperature, particularly at or above the rock temperature at the ore body. Saturated brine can simply be cooled to recover ore in a simple crystallizer plant, with barren brine from the crystallizers being reheated and returned to the mine to further dissolve potash from the ore body. This eliminates the need for expensive evaporation equipment and high operating costs associated with such equipment. Small amounts of water can be added to the heated brine to produce the amount of brine needed to replace ore dissolved from the mined area. This results in the dissolution of about 10% of the salt in the mined area. In a mine utilizing these methods, salt liberated from the ore (as the potash dissolves) can be deposited in the mined-out regions, so only minimal amounts of salt ever are brought to the surface.

The temperature of the saturated brine can be established by adjusting the temperature of the input brine. This either cannot be done, or can be done only in a very limited extent in conventional systems. The subject methods and systems can be used on shallow deposits with low rock temperature as well as on deeper deposits, the latter currently being the only candidates for solution mining.

Processes described herein are essentially opposite to conventional processes by setting up circulation first, with caverns being formed horizontally due to the established circulation of brine. The mine is developed from horizontally drilled holes that are interconnected with each other to form a labyrinth, with brine returning to the surface in a vertical production well. The holes are drilled vertically to the ore layer, then horizontally through the ore deposit near the bottom of a selected mine zone. Curved caverns develop at the intersections of the holes as hydraulic flow is concentrated around the peripheries of the caverns. (Salt is deposited in the insides of the curves). As needed, additional holes can be drilled in the mine field.

As the caverns form, horizontal meanders develop due to sinusoidal hydraulic flow patterns. In a potash mine, for example, potash in the ore deposit dissolves according to a sine curve, with salt being deposited on the insides of the curves. The sinusoidal patterns are similar to corresponding patterns assumed by a meandering stream. The resulting combinations of intersections and meanders create an undercut of the ore body. The undercut has a circular cross section, typically about 1 meter in diameter but dependent upon the fluid flow rate and the ore characteristics,) at the periphery. A thin, low-flow zone forms by dissolution over the salt deposit. This slow-flow dissolution zone extends the cavern vertically over time to dissolve out the entire ore deposit. Over time, circulation patterns extend to reach most of the ore by dissolution, with vertical dissolution in low-flow areas removing the vertical extent of the ore body.

Importantly, progressive removal of ore from the mine remains under continual flow throughout the life of the mine. This simplifies surface piping because production well(s) can be located close to a plant on the surface, thereby reducing pipeline costs and reducing concerns about saturated brines undesirably crystallizing on the inside surfaces of pipelines extending from the mine to the plant.

Product can be recovered from a saturated brine from a solution mine using a simple plant on the surface. In general, product is recovered from the brine by cooling the brine. Conventional vacuum crystallizers can be used, but as noted above these are limited to cooling to about 25 degrees C. A combination of vacuum crystallizers plus contact-cooled crystallizers, or contact-cooled crystallizers alone, are useful particularly in Northern climates, in which natural cold is available through part of the year for use in cooling of brines to as low as −4 degrees C.

According to another embodiment of solution mining, an ore body is identified at a location below ground. A hydraulic feed path including a feed path, channels, and a delivery path is established through the ore body. A solvent is circulated through the feed path, channels, and delivery path to dissolve the ore and thus carry the ore to the surface through the delivery channel. The material exiting via the delivery path is cooled to recover product therefrom using a simple crystallizer plant. As the crystallizer plant produces product, the leftover barren brine from the crystallizers is reheated and returned to the mine to participate further in dissolving more ore from the ore body. The crystallizer plant performs large-scale, low-temperature crystallization in saturated brine supplied to it, and high heat exchange is achieved by establishing certain cooling patterns and shear inside the crystallizers. The crystallizer plant can operate on a large-scale basis and is simple in design. The crystallizers have interior surfaces that, during operation, are continually wiped. Crystal growth (of product removed from the mine) is enhanced by direct contact of supersaturated brine supplied to the crystallizers with crystals being formed in the crystallizers.

In solution mining of potash, the solubility of potash in a saturated salt solution depends almost linearly on temperature. This is exploited to advantage in the use of crystallizers, in which brine containing ore that has been dissolved at about 90 to 95 degrees C. is cooled with application of vacuum to 25 to 30 degrees to precipitate the potash. The temperature difference is about 60 degrees C. (this brine is called “60-degree brine”). Almost identical amounts of potash can be dissolved and recovered from 60-degree brine at various temperatures, including 60-degree brine cooled to 0 degrees. At each of various recovery temperatures, the same amount of heat is used and the same amount of product is produced from a 60-degree brine, using 33% more brine and cooling to 20 degrees.

The big advantage of operating at lower temperature is the availability of low-grade heat from the earth, or from other parts of a mining plant at the surface. Heat losses are also lower to well strings, etc.

Saturated brines from a mine at 60 to 80 degrees C. (even as low as 30 to 40 if needed) are near full saturation. These brines can be fed to the first of a series of ECWSC units, cooled by about 10 to 15 degrees, to produce high-purity potash crystals. The partially cooled brine then flows to the next unit, and so on in a series of up to 5 units. Final brine temperature from the last unit is typically 0 to 20 degrees C. Crystal passes forward through the series of units and is finally pumped forward to a centrifuge and dryer. Larger installations may use several parallel lines of crystallizers. Cool, barren brine from the crystallizers can be reheated in heat exchangers, using warmed cooling media, recovered heat from the process, and/or steam or hot water from a fuel-fired boiler.

The externally circulated, wiped-surface crystallizer used herein is a significant advancement over the scraped-surface crystallizers that have been used in the sodium sulphate industry. The current crystallizers have the significant advantage of being able to cool to as low as 0 degrees C., or even lower when supplied with a suitable coolant. In addition, they are simple to operate, inexpensive, and allow recovery of most of the heat.

A cooling medium, at a temperature of as low as 0 degrees C. or lower, can be supplied in winter months (in Canada) using an air-cooled heat exchanger or a small brine pond. Summer operation is generally limited to 16 to 25 degrees C. using a pond or a cooling tower. Some refrigeration can be used in the summer months, with the amount of refrigeration being selected based on cost to balance the added pumping costs of increased flow rates to the mine.

A wiper system includes a series of wiper blades that wipe around the inside surface of a conical drum. Liquid taken from the top of the crystallizer is recirculated back to a bottom collecting hopper so as to generate a suspension of crystals in the liquid gradually moving upwardly in the conical drum. The crystals thus form in the body of liquid and tend to grow rather than create new small crystallization nuclei. As the crystals grow and become heavier they tend to collect and settle at the bottom of the crystallizer to enter the bottom hopper from which the crystals are tapped off continually or periodically.

In these crystallizers, heat can be recovered from a cooled mother liquor by using the mother liquor as a cooling medium for warmer crystallizers. The crystallizers have cooling jackets in which fluid flows at high flow rates in ducts or channels in the cooling jacket to produce high heat-exchange rates. High flow rates are obtained by selecting the right number and rotation of wipers on the interior surfaces where heat exchange occurs. With proper selection of conditions, there is no build-up of crystals in the crystallizer, allowing the crystals to settles to the bottom discharge hopper of the crystallizer for collection.

An external circulation leg, pumping the return liquid to the bottom, maintains the crystals in suspension and incorporates fresh feed into the liquid suspension in the crystallizer. This arrangement has the potential to improve crystal growth over other crystallizer systems. The current crystallizers favor production of supersaturated brines and coarse crystal beds, which reduce or eliminate the need for subsequent compaction of the recovered crystals, so long as coarse crystals can be grown sufficiently through the crystallization process.

A saturated brine from a properly designed and operated solution mine can be converted to a final product using a simple plant. Product is recovered from the brine by cooling the brine. Conventional vacuum crystallizers can be used, but they are limited to cooling to about 25 degrees C. A combination of vacuum crystallizers plus contact-cooled crystallizers, or contact-cooled crystallizers alone, can be used to advantage especially in Northern climates in which natural cold is available through part of the year to provide cooling media as low as −4 degrees C.

The systems described herein are improved crystallization systems for large-scale, low-temperature crystallization applications. The units are simple in design, providing high heat exchange through the use of specially designed cooling patterns and shear inside the crystallizer as wipers continually wipe the surface. Crystal growth is enhanced by direct contact of the supersaturated brine with growing crystals.

Whereas processes are described herein in the context of potash mining, the solution-mining processes are applicable to bitumen extraction from tar sands using organic solvents, emulsifying agents in water, and/or organic solvent bases or hot water. Sand may be left in the deposit in whole or in part, or alternately brought to the surface for separation. The sand can be returned to the deposit in whole or in part in the form of barren feed to the mine. The processes may also be used in the extraction of other soluble minerals including soda ash, salt, etc., from ore deposits. A special application would be removal of high-grade uranium. A network of horizontal holes could be used as described for the potash application, although in a tighter pattern for uranium, along with acid- or carbonate-extraction solutions (well known in uranium mining) to remove the ore. High flow rates may be used in the caverns formed in the ore deposit to erode the uranium ore. Clays and sand will either remain in the caverns, or be brought to the surface, where the clay and sand are separated from the leachate. The coarsest material can be returned to the caverns to backfill the mined-out area. Coarse sand suspended in the circulating liquid can be used to enhance the erosion of the relatively hard uranium ore.

Processes described herein may offer one or more of the following advantages: (1) low capital cost (about 1/10 of a conventional potash operation), (2) no solid tailings are produced, (3) lower energy cost than existing solution mines, (4) can be developed as a small operation and still be viable, (5) leaves a small footprint, (6) low operating cost (about an 80% reduction compared to conventional methods, (7) high recovery from a small mine area (2,000,000 to 10,000,000 tonnes/square mile for potash), (8) low carbon footprint (virtually no chemicals used in the process, except small amounts of chemicals for boiler feed water, etc., (9) uses less energy than existing solution mines, and (10) short time from start of construction to full production.

Horizontal drilling in a potash application may be directed by continuous monitoring of gamma radiation, as is done in certain oil drilling applications. Potash has a natural K40 isotope producing a gamma radiation. The horizontal portion of the hole will normally not be cased.

Another advantage of the current systems and methods is the possibility of locating the production well or wells near a plant as a permanent installation. This reduces surface pipe cost. Two parallel holes or pipelines may be needed for the feed lines to the wells. Overall, the surface disruption to agriculture, etc., is minimal. The fact that there are no salt tailings is hugely significant in a potash mining operation.

### BRIEF DESCRIPTION OF THE DRAWINGS

An embodiment of the invention will now be described in conjunction with the accompanying drawings in which:

FIG. 1 is a schematic illustration of a conventional solvent-mining system.

FIG. 2 is a schematic illustration of a solvent-mining system according to the present invention showing a series of horizontal connecting bores and showing cavern development over time as caused by brine flow through the connecting bores.

FIG. 3 is a similar schematic illustration of a solvent-mining system according to the present invention showing horizontal connecting bores and the vertical production hole or well.

FIG. 4 is a schematic illustration similar to FIG. 3 showing the development of meanders or caverns over time caused by the brine flow through the bores.

FIG. 5 is a schematic cross-section of an intersection cavern.

FIG. 6 is a schematic layout of an above-ground crystallization extraction system according to the present invention.

FIG. 7 is a vertical cross-sectional view of one of the crystallization components of FIG. 6.

FIG. 7A is a vertical cross-sectional view taken along the lines 7A-7A of FIG. 7.

In the drawings, like characters of reference indicate corresponding parts in the different figures.

### DETAILED DESCRIPTION

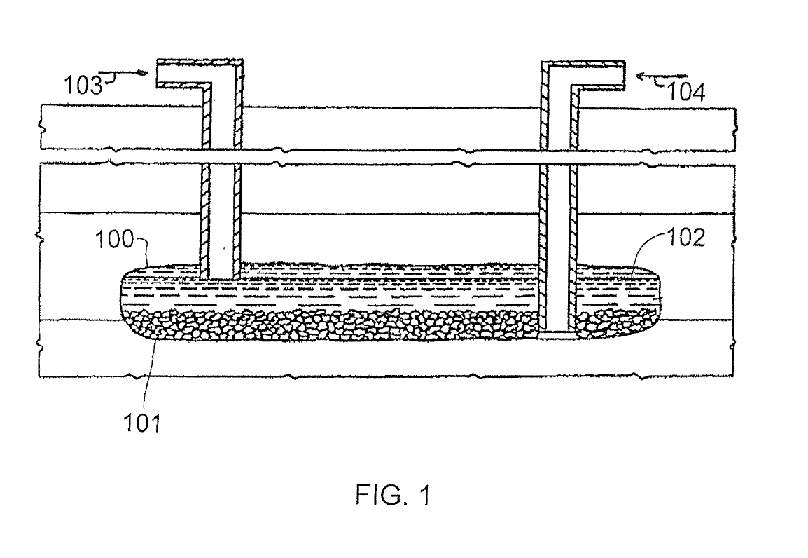

FIG. 1 shows and provides more detail of a conventional solvent-mining system as described above. The conventional solution mine creates individual caverns 100 by dissolving salt 101 from beneath the ore body 102 and rubblizing the ore into the cavern. Meanwhile, the ore is dissolved in a solution of fresh water or dilute brine 103 to form near-saturated solutions at temperatures equal to the temperature of the ore (or slightly higher). The caverns tend to develop vertically and, in some cases, connecting caverns. To recover the ore from the solution 104, evaporation and crystallization systems are necessary at the surface.

With a conventional solution-mining system, it is difficult to raise the mine temperature in the cavern 100 above the temperature of the ore. It is also difficult to obtain fully saturated brines in the solution 104. Thus, at the surface of a conventional system, ore (e.g., potash) concentration and temperature are increased using evaporators. These evaporators constitute the most expensive part of the plant and use large amounts of expensive and exotic metals. Large amounts of steam are also required.

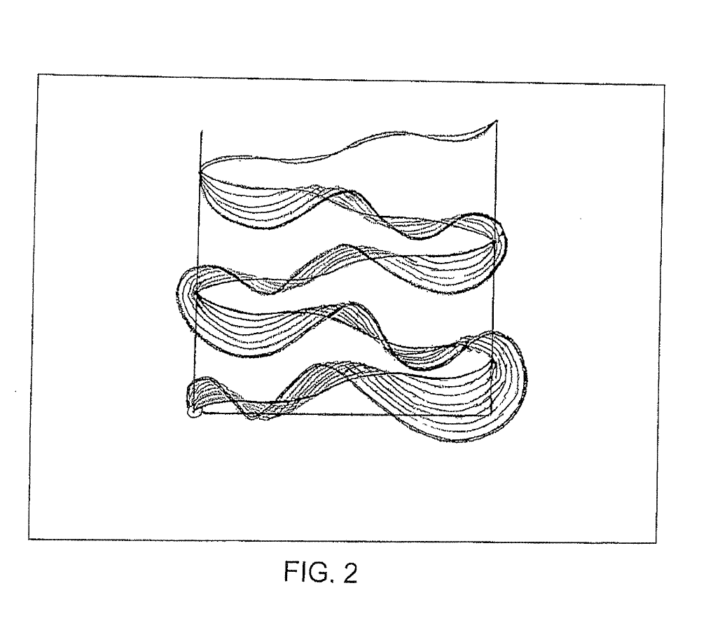

FIGS. 2-7A show and provide more detail of the solvent-mining system according to the present invention. These figures show particularly the dissolution of ore in the horizontal bores, which form meanders and chambers. The meanders and chambers allow the liquid flow to extract the ore, thus avoiding the complexities of the conventional system as described above.

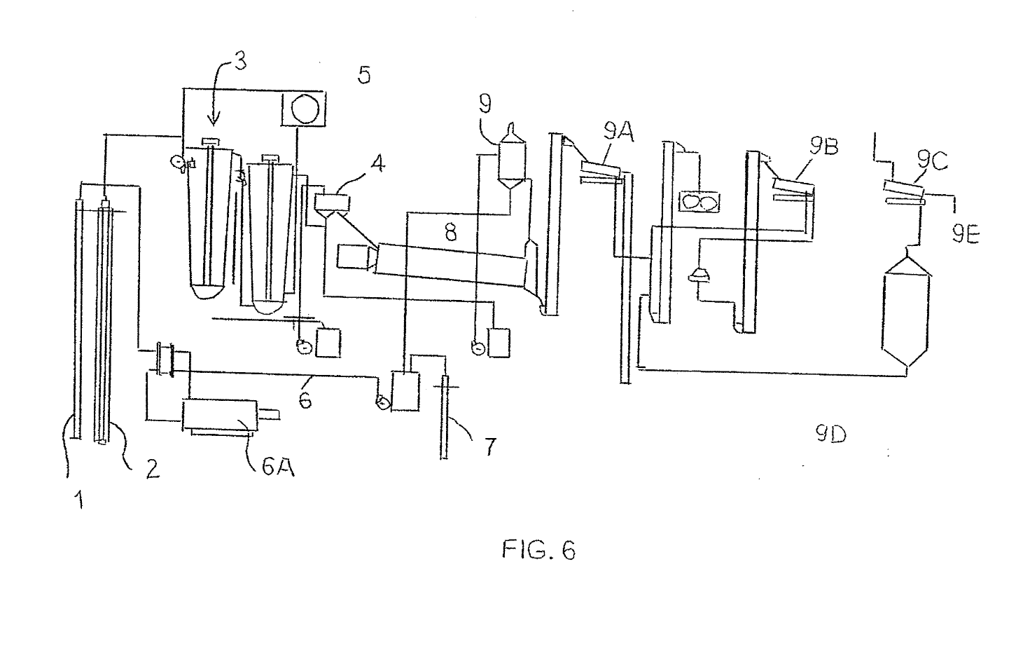

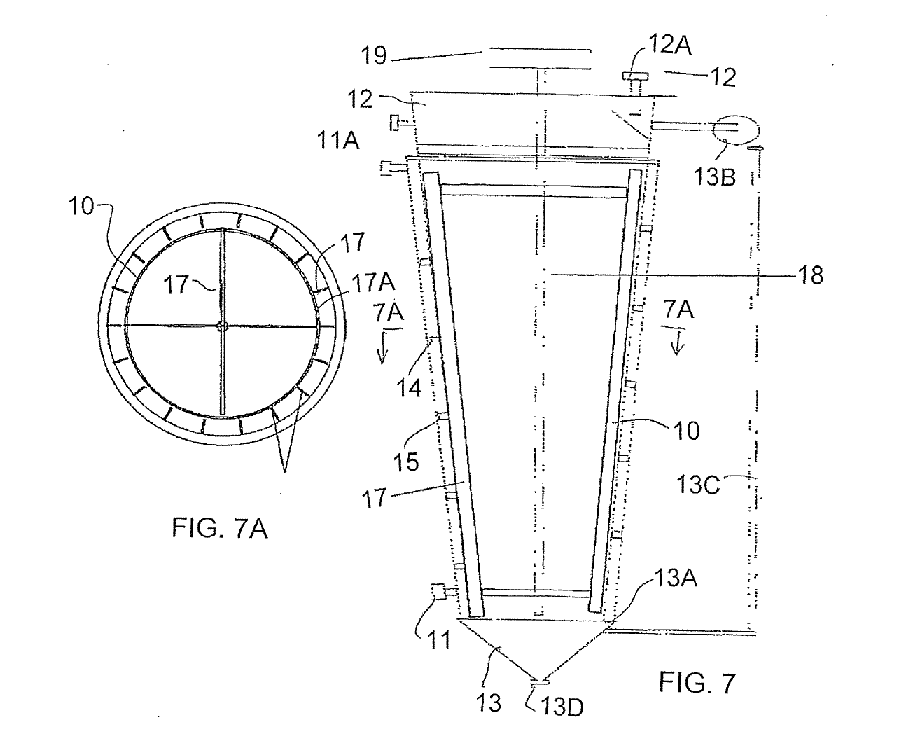

Turning now to FIGS. 6 and 7, there is shown in FIG. 6 the above-ground system for treating the solution brought up from the mine. The system includes vertical wells 1, 2 that provide an injection well 1 for returning heated brine to the ore deposit and a production well 2 that brings to the surface the solution in which the ore is dissolved.

The brine from the well is fed to the first of a series of crystallization ECWSC units 3. The units are arranged in a sequential series or row with each unit feeding to the next unit in the series.

The remainder of the system shown in FIG. 6 is simplified in view of the advantageous use of the crystallizer units. The system includes a centrifuge 4 for extracting crystals from the brine, a dryer 8, a wet scrubber 9, a series of product screens 9A for grading the recovered product, 9B for use in a possible compaction circuit, and 9C for re-screening the product prior to loading. Also shown are a granular bin 9D and a discharge to transport 9E. A water well 7 provides fresh additive water as required.

As the crystallizers are arranged to produce large crystals, the use of a compactor can be avoided, thus making downstream processing simple and effective.

The crystallizers are arranged in parallel rows, the number of rows being dependent on the quantity of solution to be treated. The number of crystallizers in each row is dependent on the amount of cooling to be produced.

The system uses heat-exchange systems to remove heat from cooling liquid (cooling “medium”) to be returned to the brine before the brine, after recovery of the therefrom, is returned to the well. This can be done by transferring the cooling medium from each crystallizer of a row to the next crystallizer in the row so that the cooling medium moves from the coolest crystallizer to the warmest crystallizer. Thus, the medium becomes heated as it removes heat from the ore solution. The heat is transferred back to the extracted brine, with additional heat being added from a boiler 6A to establish the required temperature.

FIGS. 7 and 7A show an externally circulated wiped-surface crystallizer (ECWSC), which is a significant improvement to the scraped-surface crystallizers that have been used for years in the sodium sulphate industry. These crystallizers have the significant advantage of being able to cool to as low as 0 degrees, or lower, when supplied with a suitable coolant. In addition, they are simple to operate, inexpensive, and allow recovery of most of the heat from a liquid solution passing through them.

The crystallizer comprises a conical drum 10 with a top feed 12. Solution to be treated in the line of crystallizers is fed into the first crystallizer via a feed-supply bowl 12 from an inlet 12A. The feed rate may be of the order of 4 to 5 m³/min. The drum 10 is filled to the top to define a volume (“bath”) of crystal-containing solution as the crystals are forming. A bottom hopper discharge 13 is located at the bottom of the drum for collecting the crystals falling or settling from the bath.

A surrounding heat-exchange jacket 14 includes circulating pipes or channels 15 that receive cooling medium from a supply 11 and routing the medium to a return 11A. The heat-exchange system 14 is configured to produce a cooling effect of the order of 500 to 1000 BTU/ft²/degree F., which is significantly higher than the level of cooling that is typical using a conventional system. This improved cooling allows the solution in the crystallizer to be cooled by typically 10C to 20C in each crystallizer of the series, thereby producing a total temperature drop (by all the crystallizers) of the order of 40 to 50 C.

Each crystallizer includes a wiper system 17 comprising a series of wiper blades mounted on a shaft 18 driven by a motor 19 so that the blades wipe around the inside surface of the conical drum. This wiping action stirs the liquid in the bath to maintain the crystals in suspension and to transfer cool from the cooled conical surface to the liquid of the bath.

Liquid withdrawn from the feed bowl 12 at the top of the drum is recirculated downwardly to the top 13A of the bottom collecting hopper 13 through a pump 13B and conduit 13C. This recirculative flow, which is greater in magnitude than the in-feed of liquid at the supply 12A, can be of the order of 30 m³/min, depending upon actual crystallizer sizing, to maintain a gradual upward flow of liquid in the bath 10. The conical shape increases flow at the bottom, which tends to lift and entrain the crystals in the liquid as a suspension, from which the largest crystals tend to settle due to gravity. This gradual separation and settling of crystals in the suspension at the bottom hopper 13 produces solids contents as great 40%. The crystal-laden suspension is removed via a discharge 13D. The rate of removal of product tends to match the crystallizer in-feed rate, either continually or as a batch discharge system. Remaining brine overflows the feed bowl 12 via a conduit 20 to the next crystallizer in the series.

Thus, the liquid passing through each crystallizer is cooled about 10 to 15 degrees in each crystallizer, thereby producing high purity crystals of product. The partially cooled brine and any crystals still entrained therein rein is routed forwardly to the next crystallizer unit, in a series containing up to 5 crystallizer units. Final brine temperature is typically 0 to 20 degrees C. Collected crystal product passes forwardly through the crystallizers in the series and finally is pumped forward to the centrifuge 4 and dryer 8. Larger installations may use several parallel lines of crystallizers.

Cool barren brine from the crystallizers can be reheated in heat exchangers, using the warmed cooling media, recovered heat from the process, or steam or hot water from a fuel-fired boiler 6A. In any event the brine is returned to the required temperature for return to the mine through the return line 1.

Cooling medium, as low as 0 degrees C., can be supplied in winter months from an air-cooled heat exchanger, or from a small brine pond. Summer operations may be conducted at a coolant temperature of 16 to 25 degrees C. using a pond or a cooling tower. Some refrigeration can be used as required in summer months to reduce coolant temperature, wherein the amount of refrigeration is selected based on cost to balance the added pumping costs associated with increased flow rates to the mine. The overall plant design facilitates recovery of heat by the cooled mother liquor, by using it as a cooling media from the warmer crystallizers.

The crystallizers utilize high flow rates in the ducts or channels 15 in the cooling jacket 14 to produce high heat-exchange rates. Flow rates of up to 8 feet/sec are obtained by appropriately selecting the number and rotation of wipers 17 as mounted to a mounting ring 17A, by which wipers move on the interior surfaces of the heat-exchange regions of the crystallizers. By appropriately addressing these factors, crystals do not build up in the crystallizer. Rather, the crystals are swept to or allowed to settle at the bottom discharge hopper 13 for collection and transfer to the next crystallizer in the series. An external circulation leg 13C maintains the crystal in suspension and incorporates fresh feed into the crystal suspension.

The arrangement and configuration of crystallizers described and shown herein can produce substantially improved crystal growth (and thus ore recovery) compared to conventional crystallizer systems. The current crystallizers allow production of supersaturated brines, even in the coarsest crystal beds. This reduces or eliminates the need for compaction, particularly if coarse crystals are produced in the crystallizers.

A saturated brine from a solution mine configured as described herein can provide good product recovery using a simple plant as shown. Whereas product is recovered from the brine by cooling the brine, the brine can be cooled to lower temperature than conventionally (conventional vacuum crystallizers can be used but these devices are limited to cooling the brine to about 25 degrees C.). A combination of vacuum crystallizers plus suitable contact-cooled crystallizers, or contact-cooled crystallizers alone can be used to advantage especially in Northern climates in which natural cold is available through part of the year to cool the medium to as low as −4 degrees C.

Crystallization systems as disclosed herein provide improved crystallizations of ore product from brines, including for large-scale, low-temperature applications. The crystallization units are simple in configuration and produce high heat exchange through the use of distinctive patterns of hydraulic flow through them, including hydraulic shear inside the crystallizer and the use of wipers continually wiping the inner surface of the crystallizer vessel. Crystal growth is enhanced by direct contact of supersaturated brine with the growing crystals in the “bath” (liquid in the crystallizer) while maintaining the crystals in suspension with gradual settling of crystals in the bath.

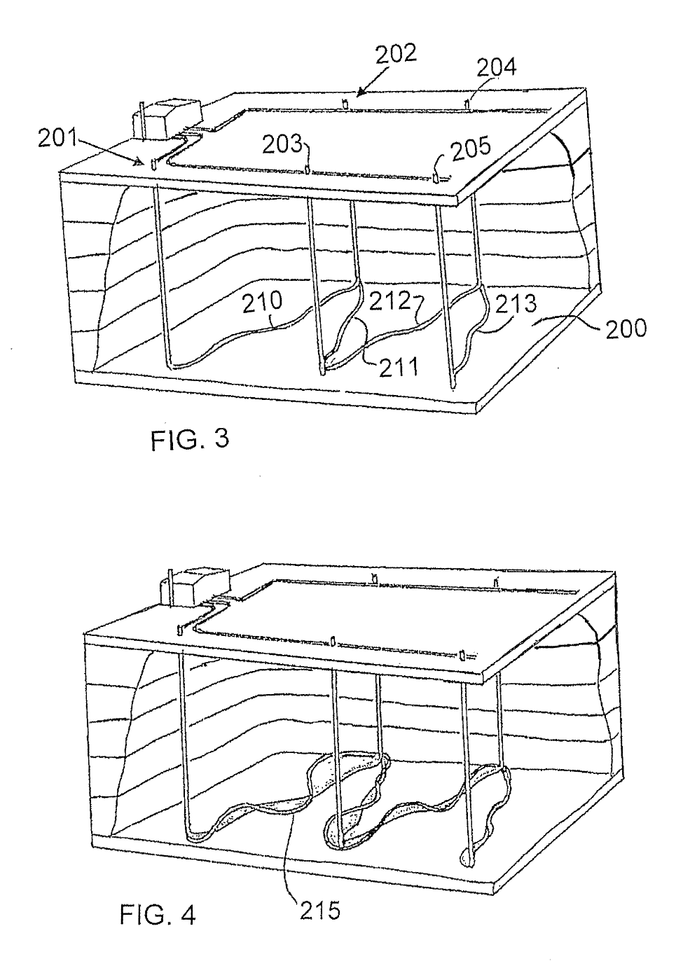

Turning now to FIGS. 2-5, an underground mining system is shown, in which the solution being treated in the above-ground crystallizer plant is used to extract the ore from brine obtained from the mine. In FIG. 3, an ore body 200 or bodies has been identified at a location below ground. A series of vertical holes 201, 202, 203, 204, 205 are drilled from the surface to the ore body or bodies. In the ore body, horizontal holes 210, 211, 212, 213 are drilled within the ore body in a direction generally parallel to the ground to interconnect portions of the ore body hydraulically. Thus, a series of channels is formed, extending through the body.

Each horizontal hole 210-213 extends through the ore body in a generally diagonal direction so that the resulting hydraulic paths extends forwardly in the body and across the body. The hydraulic paths formed by the horizontal holes 210-213 are arranged in a zig-zag pattern across the ore body. The zig-zag pattern can be curved in sinusoidal manner.

The vertical holes 201-205 extend from the surface to respective ends of the ore deposit and provide a respective number of feed paths to the interconnecting horizontal holes 210-213, thereby providing respective feed paths to the mine and respective delivery paths from the mine. The horizontal holes 210-213 are each drilled in the sinusoidal or zig-zag pattern back and forth across the ore body to promote establishment of long-wavelength meanders through the ore deposit. The sinusoidal zig-zags can be, for example, 1.5 to 2.5 full wavelengths per vertical hole.

Solvent is routed through the feed path to the ore, through the ore via the series of channels, and out of the mine via the delivery path as the solvent dissolves the ore and carries the dissolved ore to the surface via the delivery path.

The flow of solvent in the zig-zag channels forms caverns in the ore by dissolution and erosion of the sides of the channels. This erosion and dissolution favors the formation and preservation of meanders 215 from swirl patterns of solvent flow through the ore as the solvent dissolves and erodes the side walls of the channels. The swirl patterns are determined in part on the hydraulic flow through the channels. This flow widens the holes generally in the same horizontal plane as the holes 210-213 to sweep out the ore over time as erosion and dissolution continues. This is shown in FIG. 4, in which the solvent swirls from side-to-side and progressively enlarges one side and then the other side of the channel at different locations along the length of the channel, depending on flow patterns.

With the zig-zag pattern of hydraulic flow, long-wavelength meanders are formed that are uniform in periodicity, which facilitates the formation of the caverns. The channels exhibit a directional change at each path intersection. This directional change results in the formation of a large-diameter cavern at each intersection as salt is deposited inside the curves of the cavern. Over time the meanders increase in size and thus dissolve and erode ore material on each side of the holes 210-213 until the entire ore bed is substantially removed.

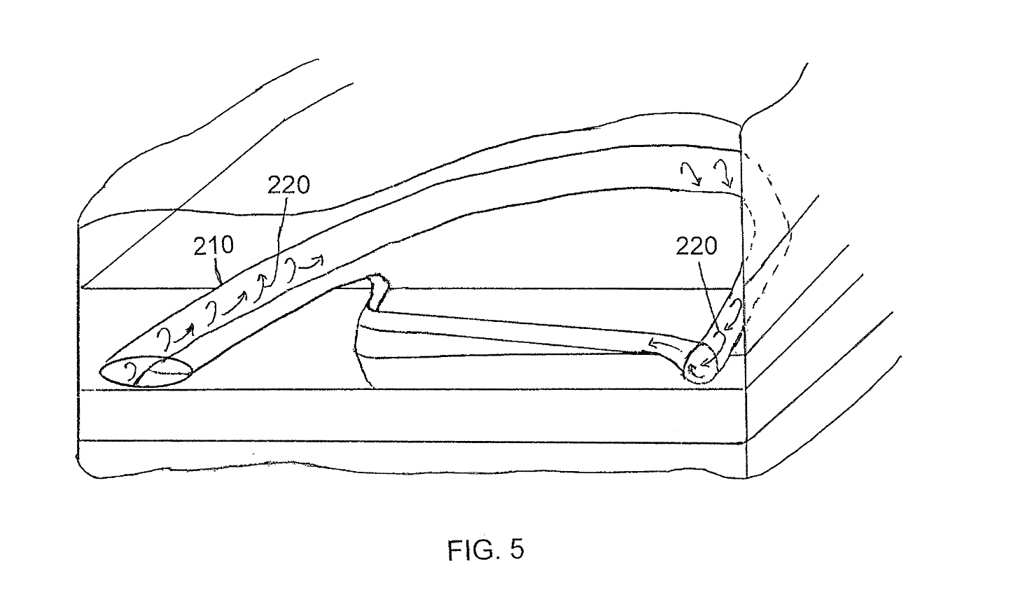

The effect of this hydraulic flow through the horizontal holes 210-213 is shown in FIG. 5, in which the inside surfaces of the original hole have been eroded and dissolved by swirl patterns 220 that produce helicoidal solvent flow. Helicoidal flow causes high shear against the wall and results in rapid dissolution of ore. The slowed flow of solvent resulting from increases in the sizes of the meanders into salt (halite) deposits in the ore causes back-leaching or slow dissolution of the ore and erodes halite from the front roof of the cavern. The resulting holes and hydraulic flow are arranged such that caverns develop at the intersections of the holes while hydraulic flow is concentrated around the periphery of the cavern.

The combination of the intersections and meander development creates an undercut of the ore body. The undercuts have circular cross-sections, and are formed at the peripheries of thin zones of low-flow dissolution over the salt deposits. The slow dissolution zones extend the caverns vertically over time to dissolve out the entire ore body.

The holes 201-205 are drilled vertically to the ore layer, then horizontally through the ore zone near the bottom thereof. The vertical holes can be 1000 to 2000 meters (or more) in length. The forward displacement of each hole in its diagonal path can be of the order of 250 meters. In this way, a zig-zag path of 1.5 half wave lengths using three injection wells and one production well will move forward by 3×250 or 750 meters. One such arrangement involving a single feed-in hole and a single return hole can extract ore over an area of roughly 1000 by 750 meters.

During operation, the parameters of temperature and flow rate are controlled so that, as solvent enters the ore deposit, material exiting the discharge hole is substantially saturated with dissolved ore. Also, delivery of solvent is controlled so that material exiting the discharge hole is at a temperature at or above the temperature of the ore body. Solvent temperature can be set by adjusting the temperature of the brine entering the mine.

As explained above, material exiting the discharge hole is processed to recover the ore therefrom. The material is cooled in a crystallizer plant that includes one or more crystallizers. Barren brine from the crystallizers is reheated as required and returned to the mine to dissolve further material out of the ore body. The whole process can be conducted without the need for evaporation equipment. The crystallizers are arranged for large-scale, low-temperature crystallization.

If necessary, water can be added to solvent returning to the mine. The water, added via a solvent-feed conduit to the mine, re-forms the solvent needed to replace the ore (e.g., potash) dissolved from the ore deposit in the mine. Thus, salt (halite) released from the ore in the mined area is returned to the ground so that it never leaves the mined area. Only minimal amounts of salt ever are brought to the surface. The amount of water added is sufficient to produce enough brine to occupy the volume of ore dissolved in the mine. Water may be added at the main hot-brine feed stream. However, an advantage can be gained by adding water selectively to individual feed wells to manage cavern development.

The subject mining systems and methods can be applied to shallow ore deposits with low rock temperature, with mid-range deposits normally not amenable to conventional solution-mining methods, or with deep deposits, including those normally accessed by conventional solution-mining techniques. As mining of a particular ore deposit progresses, additional holes can be drilled as needed to develop the ore field further and/or for returning the ore in solution to the surface for providing feed brine to the surface plant. These additional wells can all be fed with solvent brine through the existing labyrinth and exit the mine via a single production well. At some point a parallel development may be required using a series of new horizontal wells connected to a new production well. All production wells will normally be located close to the surface plant.

Since various modifications can be made in my invention as described hereinabove, and many apparently widely different embodiments of same made within the spirit and scope of the claims without department from such spirit and scope, it is intended that all matter contained in the accompanying specification shall be interpreted as illustrative only and not in a limiting sense.

1. A method of solution mining comprising:
identifying an ore body or bodies at a position below ground;
drilling at least one hole from the surface downwardly to an ore body; drilling a hole in a direction generally parallel to the ground to interconnected portions of the ore body to form a series of channels extending through the body;
the holes from the surface being connected to two ends of the interconnected portions to provide a feed path to and a delivery path from the series of channels; and
circulating a solvent through the feed path, the series of channels and the delivery path so as to dissolve the ore and carry the ore to the surface through the delivery channel.

2. The method according to claim 1 wherein the holes are drilled vertically to the ore body, then horizontally through the high grade ore zone near the bottom of a selected mine zone in the ore body.

3. The method according to claim 1 wherein the holes in the ore body and the flow therethrough are arranged such that caverns develop at the intersection of the holes as the flow is concentrated around the periphery of the cavern.

4. The method according to claim 1 wherein the solvent is arranged such that the material exiting through the delivery path is substantially saturated with the dissolved ore.

5. The method according to claim 1 wherein the solvent is arranged such that the material exiting through the delivery path is at a temperature at or above the rock temperature at the level of the ore body.

6. The method according to claim 1 wherein the material exiting through the delivery path is processed to extract the ore by cooling the material in a crystallizer plant including a series of crystallizers, with the barren brine from the crystallizers being reheated and returned to the mine to dissolve material out of the ore body.

7. The method according to claim 6 wherein the processing is carried out without evaporation equipment.

8. The method according to claim 6 wherein the crystallizers are arranged for large scale low temperature crystallization.

9. The method according to claim 6 wherein each crystallizer comprises a vessel with an exterior cooling system and an internal wiping system providing shear inside the vessel.

10. The method according to claim 9 wherein a plurality to wiper blades is provided continually wiping the inner surface of the vessel so that crystal growth is enhanced by direct contact of the solvent with the growing crystal.

11. The method according to claim 6 wherein a quantity of water is added to the heated solvent to be returned through the feed path to create the solvent needed to replace the dissolved ore in the mined area.

12. The method according to claim 11 wherein the deposition of the salt liberated from the ore in the mined area is returned to the mined area so only minimal amounts of salt ever are brought to surface.

13. The method according to claim 1 wherein the solvent temperature is set by adjusting the input brine temperature.

14. The method according to claim 1 used on shallow deposits with low rock temperature.

15. The method according to claim 1 wherein as needed additional holes from the surface are drilled developing the mine field for returning the ore in solution to the surface.

16. The method according to claim 1 wherein the combination of the intersection and meander development creates an undercut of the ore body, with a circular cross section, at the periphery and a thin zone of low flow dissolution over the salt deposit whereby slow dissolution zone extends the cavern vertically over time to dissolve out the entire ore zone.

17. A method of solution mining comprising:
identifying an ore body or bodies at a position below ground;
generating a feed path through the ore body or bodies;
circulating a solvent through the feed path, the series of channels and the delivery path so as to carry the ore to the surface through the delivery channel.
wherein the material exiting through the delivery path is cooled to produce product in a simplified crystallizer plant with the barren brine from the crystallisers reheated and returned to the mine to dissolve material out of the ore body;
and wherein a crystallization system is provided for large scale low temperature crystallization applications where high heat exchange is provided through cooling patterns and shear inside the vessel.

18. The method according to claim 17 wherein this eliminates the need for expensive evaporation equipment and the high operating cost associated with this equipment.

19. The method according to claim 17 wherein the crystallizer has an external recirculation system for developing an upward flow in the bath to maintain the crystals in suspension with a series of blades for wiping the interior surface.

20. The method according to claim 17 wherein wiper blades are provided continually wiping the inner surface so that crystal growth is enhanced by direct contact of the solvent with the growing crystals.

21. The method according to claim 17 wherein the container of the crystallizer is conical so as to provide an increased flow rate adjacent the bottom.
